(19) United States
(12) Patent Application Publication
(10) Pub. No.: US 2007/0244897 A1
(43) Pub. Date: Oct. 18, 2007

(54) Methods and systems for change management for a group policy environment

(76) Inventors: David Voskuil, Portsmouth, NH (US); Eric K. Voskuil, Somersworth, NH (US); Kevin Sullivan, Lee, NH (US)

Correspondence Address: SENNIGER POWERS (MSFT), ONE METROPOLITAN SQUARE, 16TH FLOOR, ST. LOUIS, MO, 63102, US

(21) Appl. No.: 11/405,865

(22) Filed: Apr. 18, 2006

(51) Int. Cl. G06F 17/30

(52) U.S. Cl. 707/9

(57) ABSTRACT

Comprehensive change control and enhanced management of GPOs in a client-server environment is described. A Group Policy Management Console (GPMC) extension provides seamless integration with GPMC. The application or extension provides a secure archive for controlling changes to GPOs. To change a GPO, an administrator “checks out” the GPO from the archive or vault. When changes are complete, the GPO is “checked in” to the vault. Differences between archived versions and/or live versions are reviewed using GPMC-style reports. When a GPO is ready for deployment, it can be transferred to the live environment. At any time, one or more live GPOs can be “rolled back” to an archived version. GPO data in the secure archive is maintained in XML files, greatly reducing infrastructure requirements.

### BACKGROUND OF THE INVENTION

1. Field of the Invention

The disclosed methods and systems relate generally to securing resources and privileges on a computer, and more particularly to controlling and administering changes to security policies.

2. Background Information

Group Policy is an architecture that defines how security and configuration policy is delivered to users and computes throughout an Active Directory enterprise. A system boots into a network or a user logs onto a system on the network and the Group Policy environment delivers a rich set of configuration data. However, managing this environment can be challenging.

In WINDOWS®, a Group Policy Object (GPO) is a collection or grouping of configuration settings that are applied to computer users and/or computers/systems automatically and/or remotely. Group Policy is a MICROSOFT® implementation of the general concept of policy-based management, which is a computer management model. One potential implementation of a group policy system is described in U.S. Pat. No. 6,466,932. By applying the configuration settings to the computers/systems, a system administrator or other entity may define and/or set the behavior and/or “appearance”/configuration of the computers/users. Accordingly, a GPO is generally configured by a system administrator or other high-level administrator, and as an object, a GPO can be associated with a hierarchical grouping known as a “container.” A container may be a domain, a site, an organization unit (OU), or other association of computers/systems/users. In some example instances, a GPO may define script options, security options, software-installation options, folder-redirection options, software-maintenance options, and other configuration options.

Each GPO has a list that controls whether the GPO's settings are applied to given users, groups, and/or computers. An entity that is on the list has the GPO's settings applied to it. An entity not on the list does not, at least in response to that GPO. The use of groups, as opposed to user- or computer-identities, as the criterion on which the settings-application decision is made may be referred to as GPO-level filtering. Accordingly, GPO-level filtering allows a system administrator or another to specify whether a GPO is applied or denied to users/computers. The GPO is thus applied in its entirety, or denied in its entirety, to a user/computer/system.

In a MICROSOFT® WINDOWS® implementation, GPOs are populated with settings by a Group Policy Object Editor (GPOE). The GPO settings are applied on client computers by corresponding extensions, called Client-Side Extensions (CSEs). An Active Directory (AD) on the network server maintains the GPO definitions, settings, extensions and other system data for the network. There is a documented extension model that MICROSOFT® provides for software vendors to extend these systems and, by doing so, provide new functionality within the WINDOWS® Group Policy architecture.

GPOs are created and managed through the WINDOWS® Group Policy Management Console (GPMC). Changes to GPOs take affect immediately on modification. Within the GPMC, there is no mechanism to manage Group Policy securely and maintain a history of the GPOs being managed. Further, there is no maintenance of information related to who made changes to a GPO, when the changes were made and what the differences are between the proposed changes and what is currently live in the production environment.

In order to allow access to the Group Policy data there needs to be a delegation model available to define what user has what level of access to Group Policy. The delegation model provided by WINDOWS® GPMC provides a mechanism to delegate permissions directly to the live Group Policy/Active Directory environment. Organizations require a process where users can access Group Policy data without the ability to modify the live production environment. If a ‘delegated administrator’ were given permissions to one or many GPOs, any changes made to those GPOs would be automatically accepted into the system with no provision for approval or checking of the changes being made. If changes have an unexpected adverse impact, there is no way to quickly rollback or revert them to a known good state. Under GPMC, the editor role has full permissions to deploy changes to the live environment, and must do so to edit settings. Creating and maintaining a securely delegated archive of the configuration data, allowing for offline editing, is needed. Group Policy and the GPMC provide the baseline for a rich configuration environment but certain, very important areas of functionality are missing.

Using the documented extension model, other implementations have attempted to address the GPO editing problem. However, such implementations have not been fully integrated with GPMC, generally requiring a separate user interface. In addition, these implementations generally require extensive infrastructure, such as database management systems, to support the large database structures used.

### SUMMARY OF THE INVENTION

To address these and other disadvantages, a GPMC extension, referred to herein as GPOVault™, is described that provides seamless integration with GPMC for comprehensive change control and enhanced management of GPOs in a client-server environment. GPOVault™ provides a secure archive of GPO definitions, settings, extensions and other pertinent GPO data derived from the AD, for controlling changes to GPOs. To change a GPO, an administrator or other user having the appropriate permission “checks out” the GPO from the secure archive, or vault. For the purposes of description, the terms vault and archive may be used interchangeably herein. When changes are complete, the GPO is “checked in” to the vault. Differences between archived versions and/or live versions are reviewed using GPMC-style reports. When a GPO is ready for deployment, it can be transferred to the live environment, i.e., transferred to the AD. At any time, one or more live GPOs can be “rolled back” to an archived version. GPO data in the secure archive is maintained in XML files, greatly reducing infrastructure requirements.

In a first embodiment, a method for change control management of group policy objects for a network includes creating an archive of group policy objects on a server, assigning permissions to users for performing at least one operation of editing, reviewing and approving of changes to the group policy objects in the archive, implementing an enhancement of a group policy management control user interface on a client to provide a node in the user interface, whereby a user can access change control management tools for performing the at least one operation of editing, reviewing and approving of changes to group policy objects in the archive consistent with the permissions assigned to the user, and deploying only approved changes from the archive to an active directory for the network.

In some aspects, creating an archive includes maintaining copies of previous and current versions of the group policy objects. Creating also may include creating an XML file including, for each group policy object version, a group unique identifier and version data. A user interface can access the XML file for displaying the version data to the user. The version data can include client meta-data and the client meta-data can include user data, time data, state data, status data, owner data and/or text data for identifying a creation of a version, a current state of a version, an enabled status of a version and/or comments regarding the version. The state data of a version can identify a deployed state when the version is currently live on the network, a checked in state, indicating the version is available for editing and/or deployment to the active directory, and/or a checked out state, indicating the version is currently checked out and is not available for editing.

In some aspects, assigning permissions can include assigning at least one permission to at least one setting within a group policy object without assigning that one permission to other settings within the group policy object. In some aspects, deploying can include reviewing changes made to the group policy objects and approving the changes made to the at least one of the group policy objects.

In a related embodiment, a data structure for change control management of group policy objects for a network resides on a server and includes an archive of previous and current versions of the group policy objects and an XML file including, for each group policy object version, a group unique identifier and version data, wherein a change control management user interface accesses the XML file to display the version data to a user on a client.

In some aspects, the version data comprises client meta-data, including user data, time data, state data, status data, owner data and/or text data for identifying a creation of a version, a current state of a version, an enabled status of a version and/or comments regarding the version. The state data of a version can identify a deployed state when the version is currently live on the network, a checked in state, indicating the version is available for editing and/or deployment to the active directory, and/or a checked out state, indicating the version is currently checked out and is not available for editing.

In another embodiment, a method for change control management of group policy objects for a network includes creating an archive of group policy objects on a server, allowing an administrator of the method to assign a permission to a user for at least one of editing, reviewing and approving changes to a setting within a group policy object in the archive without assigning the user a permission regarding other settings within the group policy object, allowing a user to perform at least one of editing, is reviewing and approving a change to at least one setting within a group policy object based on the permissions assigned to the user, and deploying an approved change from the archive to an active directory for the network.

In some aspects, the method includes implementing an enhancement of a group policy management control user interface to provide a node in the user interface, whereby the user can access change control management tools for performing editing, reviewing and/or approving consistent with the permissions assigned to the user. Creating an archive can include maintaining copies of previous and current versions of the group policy objects and creating an XML file including, for each group policy object version, a group unique identifier and version data, the user interface accessing the XML file for displaying the version data to the user. The version data can include client meta-data, including user data, time data, state data, status data, owner data and/or text data for identifying a creation of a version, a current state of a version, an enabled status of a version and/or comments regarding the version. The state data of a version can identify a deployed state when the version is currently live on the network, a checked in state, indicating the version is available for editing and/or deployment to the active directory, and/or a checked out state, indicating the version is currently checked out and is not available for editing.

In a further embodiment, a method for change control management of group policy objects for a network includes creating an archive of group policy objects on a server, assigning permissions to users for performing editing, reviewing and/or approving of changes to the group policy objects in the archive, implementing an enhancement of a group policy management control in a client-server environment, whereby a user on a client can access change control management tools for performing the editing, reviewing and/or approving of changes to group policy objects in the archive consistent with the permissions assigned to the user, and deploying only approved changes from the archive to an active directory for the network.

In some aspects, the method includes implementing an enhancement of a group policy management control user interface to provide a node in the user interface for accessing the access change control management tools. In further aspects, creating an archive can include maintaining copies of previous and current versions of the group policy objects. Creating also may include creating an XML file including, for each group policy object version, a group unique identifier and version data. A user interface can access the XML file for displaying the version data to the user. The version data can include client meta-data and the client meta-data can include user data, time data, state data, status data, owner data and/or text data for identifying a creation of a version, a current state of a version, an enabled status of a version and/or comments regarding the version. The state data of a version can identify a deployed state when the version is currently live on the network, a checked in state, indicating the version is available for editing and/or deployment to the active directory, and/or a checked out state, indicating the version is currently checked out and is not available for editing.

In some aspects, assigning permissions can include assigning at least one permission to at least one setting within a group policy object without assigning that one permission to other settings within the group policy object. In some aspects, deploying can include reviewing changes made to the group policy objects and approving the changes made to the group policy objects.

Other objects and advantages will become apparent hereinafter in view of the specification and drawings.

### BRIEF DESCRIPTION OF THE DRAWINGS

The invention description below refers to the accompanying drawings, of which:

FIG. 1 is a graphical user interface of a prior art Group Policy Management Console (GPMC);

FIG. 2 is a graphical user interface of a GPO change control management system integrated with the GPMC;

FIG. 3 is a graphical user interface showing domain delegation data;

FIG. 4 is a graphical user interface for submitting a request for approval for new GPO;

FIG. 5 is a graphical user interface for displaying/selecting an archive storage location;

FIG. 6 is a graphical user interface for displaying/selecting GPO templates;

FIG. 7 is a graphical user interface for displaying a history of actions taken with respect to a GPO;

FIG. 8 is a graphical user interface for displaying/selecting all historic instances of a selected GPO;

FIG. 9 is a graphical user interface for change control management at a GPO extension level;

FIG. 10 is a flowchart showing operation of a method for change control management of GPOs; and

FIG. 11 illustrates cascaded graphical user interfaces for HTML difference and settings reports and for displaying a portion of the archive for a selected setting.

### DETAILED DESCRIPTION OF AN ILLUSTRATIVE EMBODIMENT

To provide an overall understanding, certain illustrative embodiments will now be described; however, it will be understood by one of ordinary skill in the art that the systems and methods described herein may be adapted and modified to provide systems and methods for other suitable applications and that other additions and modifications may be made without departing from the scope of the systems and methods described herein.

Unless otherwise specified, the illustrated embodiments may be understood as providing exemplary features of varying detail of certain embodiments, and therefore, unless otherwise specified, features, components, modules, and/or aspects of the illustrations may be otherwise combined, separated, interchanged, and/or rearranged without departing from the disclosed systems or methods. Additionally, the shapes and sizes of components are also exemplary and unless otherwise specified, may be altered is without affecting the scope of the disclosed and exemplary systems or methods of the present disclosure.

The embodiments of the invention as described below allow designated users of a computer network, such as system administrators, to manage changes in configuration settings that are applied to computer users and/or computers/systems. Some embodiments may use a group/policy management system, where WINDOWS® GPMC is provided herein as an example of such a policy management system. In addition, embodiments of the invention are described below in connection with the user interfaces of the GPMC extension, GPOVault™, shown in the figures and described herein for illustrative purposes. Additional details regarding GPOVault™ are provided in GPOVault™ 2.2 User Guide, DesktopStandard Corporation, 2006, incorporated herein in its entirety. However, the disclosed methods and systems are not limited to such example embodiments, and may be understood to apply to other group and/or policy-based management systems, techniques and user interface configurations.

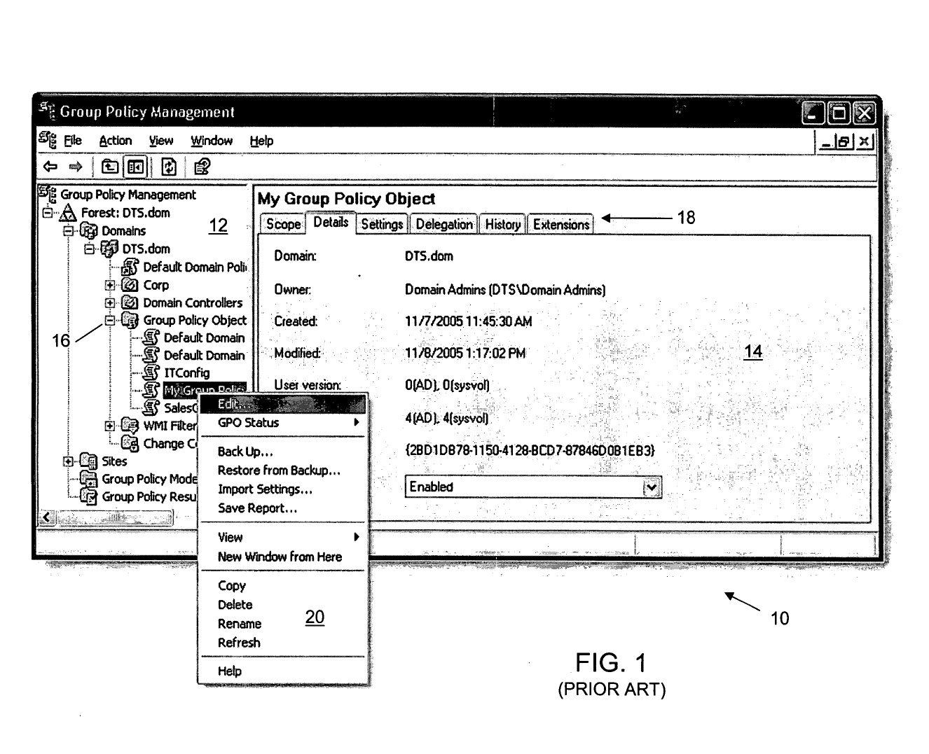

FIG. 1 shows a prior art graphical user interface 10 of the WINDOWS® GPMC. As is typical in WINDOWS® applications, the left pane 12 shows a directory or forest structure, which for the GPMC corresponds to the forest, domain and GPO levels. The right pane 14 shows the next level detail for the domain/group folder or node highlighted or chosen in left pane 12. In FIG. 1, a GPO node 16 is shown under the DTS.dom domain. The contents of GPO node 16 may include all the GPOs applicable to the DTS.dom domain. To edit or make changes to a GPO, a designated user, i.e., a user having the appropriate GPO editing rights, locates and opens the GPO node in left pane 12 to show the GPOs in the manner known in the art. When a particular GPO is highlighted, such as being left clicked on, details for the GPO are shown in right pane 14. Data for populating right pane 14 is obtained directly from the network AD. Tabs 18 above the listing provide for the presentation and/or performance of various views, data and/or operations concerning the GPOs. By right clicking on a GPO, a list 20 of editing options is presented to the user. Choosing or clicking the Edit option on list 20 results in the highlighted GPO being opened for editing directly from the network AD. By clicking OK/apply on a setting, any changes made to the GPO are saved directly to the network AD.

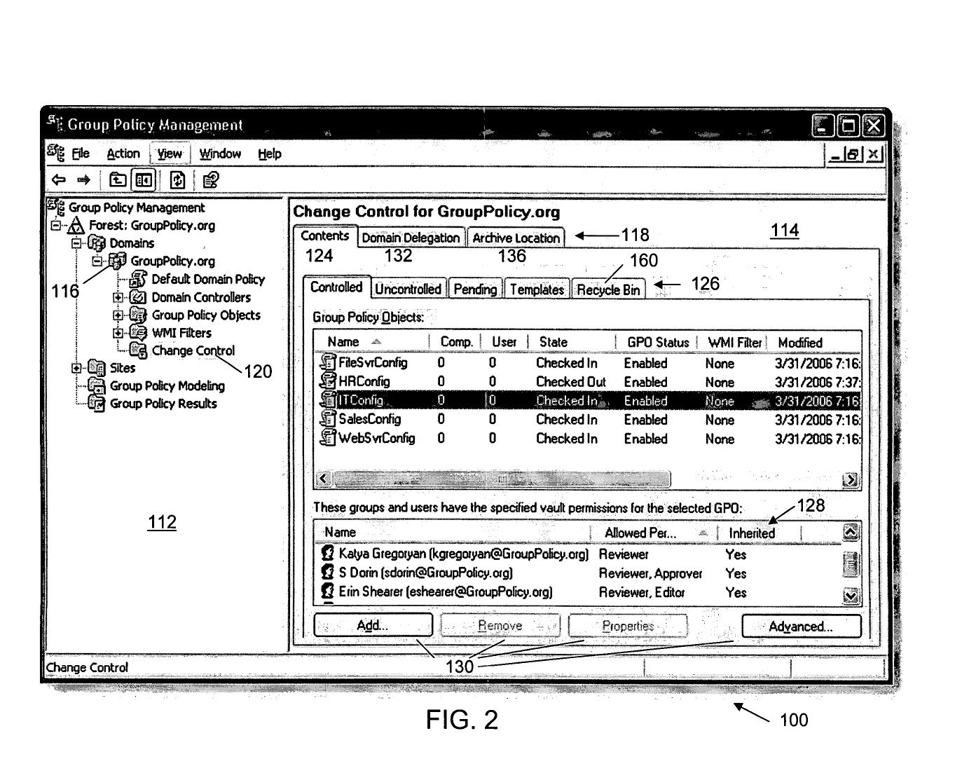

FIG. 2 illustrates a graphical user interface 100 of the WINDOWS® GPMC in which the GPMC extension, GPOVault™, has been implemented. As shown in FIG. 2, the left pane 112, right pane 114 and GPO node 116 are provided in the manner of FIG. 1. GPOVault™ provides an additional node 120, “Change Control”, at the level of GPO node 116. The “Change Control” node provides access to tools for managing changes to GPOs. When Change Control node 120 is highlighted or chosen, the user or client is provided a listing in right pane 114 of the GPOs for the corresponding node in left pane 112, as indicated in the title 122, “Change Control for GroupPolicy.org” and “Contents” tab 124 of presentation tabs 118. Additional presentation tabs 118 are provided to present data associated with “Domain Delegation” and “Archive Location”. Unlike WINDOWS® GPMC data taken directly from the AD, data for GPOVault™is obtained from a secure archive, as will be explained in more detail herein.

A group of listing tabs 126 allows the user to choose various categories of GPOs to be listed. For the exemplary screen shot of FIG. 2, the listing tabs 126 include, but need not be limited to, “Controlled”, “Uncontrolled”, “Pending”, “Templates” and Recycle Bin” categories. Under the “Controlled” tab, as illustrated in FIG. 2, the listing includes live or active GPOs for which changes are controlled, where the tab “Uncontrolled” would include other GPOs. “Pending” includes those GPOs that have been changed, but that have not been saved back to the AD. A “Template” GPO serves as a model for preparing new GPOs. The “Recycle Bin” contains GPOs that have been deleted. Right pane 114 further includes a lower pane 128 showing a listing of groups and users that “have the specified vault permissions for the selected GPO”. The listing can include other information regarding permissions, including, without limitation, the type of permission, e.g., “Reviewer”, “Editor”, “Approver”, “Administrator” and an indication of whether the permission is inherited from a higher level, e.g., from the domain or forest level. Lower pane 128 also includes buttons 130 for functionalities including, but not limited to, “Add”, “Remove”, “Properties” and “Advanced”. Depending on the permissions allocated to the user, one or more of the buttons 130 may be activated/inactivated, as indicated by inactivated buttons “Remove” and “Properties” in FIG. 2.

By right clicking on a GPO from the list in right pane 114, an action menu is displayed including various options applicable to the activated tab 126 and the GPO chosen. The options are generally displayed in groups, including without limitation, “Control and History”, “Reports”, “Editing”, Management” and “Miscellaneous”. TABLES I-V provide exemplary options available for the respective tabs.

TABLE I
Controlled

| | Effect |
|---|---|
| Control and | |
| History | |
| New | Create a new GPO with change control managed |
| Controlled | through GPOVault and deploy it to the production |
| GPO | environment. If you do not have permission to |
| | create a GPO, you will be prompted to submit |
| | a request. (This option is displayed if no GPO |
| | is selected when right-clicking in the Group |
| | Policy Objects list.) |
| History | Open a window listing all versions of the |
| | selected GPO saved within the vault. From the |
| | history, an administrator can obtain a report |
| | of the settings within a GPO, compare two |
| | versions of a GPO, compare a GPO to a template, |
| | or rollback to a previous version of a GPO. |
| | (For more information, see the History section |
| | below.) |
| Reports | |
| Settings | Generate an HTML- or XML-based report displaying |
| | the settings within the selected GPO or display |
| | links to the selected GPO(s) from organizational |
| | units as of when the GPO(s) was most |
| | recently controlled, archived, or checked in. |
| Differences | Generate an HTML- or XML-based report comparing |
| | the settings within two selected GPOs or within |
| | the selected GPO and a template. |
| Editing | |
| Edit | Launch Group Policy Object Editor to make |
| | changes to the selected GPO. |
| Check Out | Obtain a copy of the selected GPO from the |
| | vault for offline editing and prohibit anyone |
| | else from editing it until it is checked back |
| | into the vault. (Check out can be overridden |
| | by a GPOVault Administrator.) |
| Check In | Check the edited version of the selected GPO |
| | into the vault so that other authorized Editors |
| | can make changes or an Approver |
| | can deploy it to the production environment. |
| Undo Check | Return a checked out GPO to the vault without |
| Out | any changes. |
| Version | |
| Management | |
| Archive | Update the GPO stored in the vault with the |
| | currently deployed version of the selected GPO. |
| Delete | Move the selected GPO to the Recycle Bin and |
| | select whether to leave the deployed version |
| | (if one exists) in production or to delete it |
| | as well as the archive. If you do not have |
| | permission to delete a GPO, you will be |
| | prompted to submit a request. |
| Deploy | Move the selected GPO that is checked into the |
| | vault to the production environment. This action |
| | makes it active on the network and overwrites |
| | the previously active version of the GPO |
| | if one existed. If you do not have permission |
| | to deploy a GPO, you will be prompted to submit |
| | a request. |
| Label | Mark the selected GPO with a descriptive label |
| | (such as “Known good”) and comment for |
| | recordkeeping. Labels appear in the State |
| | column and comments in the Comment column of |
| | the History, enabling an administrator to |
| | rollback to a previous version of a GPO |
| | identified with a particular label. |
| Rename | Change the name of the selected GPO. If the |
| | GPO has already been deployed, the name will |
| | be updated in the production environment |
| | when the GPO is redeployed. |
| Save as | Create a new template based on the settings |
| Template | of the selected GPO. |
| Miscellaneous | |
| Refresh | Update the display of Group Policy Management |
| | Console to incorporate any changes. Some |
| | changes are not visible until the screen is |
| | refreshed. |
| Help | Display context-sensitive help for GPOVault. |

TABLE II
Uncontrolled

| | Effect |
|---|---|
| Control and | |
| History | |
| History | Open a window listing all versions of the |
| | selected GPO saved within the vault. From the |
| | history, an administrator can obtain a report |
| | of the settings within a GPO, compare two |
| | versions of a GPO, compare a GPO to a template, |
| | or rollback to a previous version of a GPO. |
| | (For more information, see the History section |
| | below.) |
| Control | Bring the selected uncontrolled GPO under the |
| | change control management of GPOVault. If you |
| | do not have permission to control a GPO, you |
| | will be prompted to submit a request. |
| Save as | Create a new template based on the settings |
| Template | of the selected GPO. |
| Reports | |
| Settings | Generate an HTML- or XML-based report |
| | displaying the settings within the selected GPO. |
| Differences | Generate an HTML- or XML-based report comparing |
| | the settings within two selected GPOs or within |
| | the selected GPO and a template. |
| Miscellaneous | |
| Refresh | Update the display of Group Policy Management |
| | Console to incorporate any changes. Some |
| | changes are not visible until the |
| | screen is refreshed. |
| Help | Display context-sensitive help for GPOVault. |

TABLE III
Pending

| | Effect |
|---|---|
| Control and | |
| History | |
| History | Open a window listing all versions of the |
| | selected GPO saved within the vault. From the |
| | history, an administrator can obtain a report |
| | of the settings within a GPO, compare two |
| | versions of a GPO, compare a GPO to a template, |
| | or rollback to a previous version of a GPO. |
| | (For more information, see the History section |
| | below.) |
| Withdraw | Withdraw a pending request to create, control, |
| | or delete the selected GPO before the request |
| | has been approved. |
| Approve | Complete a pending request from an Editor to |
| | create, control, or delete the selected GPO. |
| Reject | Deny a pending request from an Editor to |
| | create, control, or delete the selected GPO. |
| Reports | |
| Settings | Generate an HTML- or XML-based report |
| | displaying the settings within the selected |
| | GPO or display links to the selected GPO(s) |
| | from organizational units as of when the |
| | GPO(s) was most recently controlled, archived, |
| | or checked in. |
| Differences | Generate an HTML- or XML-based report comparing |
| | the settings within two selected GPOs or within |
| | the selected GPO and a template. |
| Miscellaneous | |
| Refresh | Update the display of Group Policy Management |
| | Console to incorporate any changes. Some changes |
| | are not visible until the screen is refreshed. |
| Help | Display context-sensitive help for GPOVault. |

TABLE IV
Templates

| | Effect |
|---|---|
| Control | |
| New Controlled GPO | Create a new GPO based upon the selected |
| | template. The option to deploy the new GPO to |
| | the production environment is provided. If you |
| | do not have permission to create a GPO, you |
| | will be prompted to submit a request. (This |
| | option is displayed if no GPO is selected when |
| | right-clicking in the Group Policy Objects list.) |
| Reports | |
| Settings | Generate an HTML- or XML-based report |
| | displaying the settings within the selected |
| | GPO template. |
| Differences | Generate an HTML- or XML-based report |
| | comparing the settings within two selected |
| | GPO templates. |
| Template Management | |
| Set as Default | Set the selected template as the default to |
| | be used automatically when creating a new GPO. |
| Delete | Move the selected template to the Recycle Bin. |
| | If you do not have permission to delete a GPO, |
| | you will be prompted to submit a request. |
| Rename | Change the name of the selected template. |
| Miscellaneous | |
| Refresh | Update the display of Group Policy Management |
| | Console to incorporate any changes. Some |
| | changes are not visible until the screen is |
| | refreshed. |
| Help | Display context-sensitive help for GPOVault. |

TABLE V
Recycle Bin

| | Effect |
|---|---|
| Reports | |
| Settings | Generate an HTML- or XML-based report displaying |
| | the settings within the selected GPO or display |
| | links to the selected GPO(s) from organizational |
| | units as of when the GPO(s) was most |
| | recently controlled, archived, or checked in. |
| Differences | Generate an HTML- or XML-based report comparing |
| | the settings within two selected GPOs or within |
| | the selected GPO and a template. |
| Version | |
| Management | |
| Destroy | Remove the selected GPO from the Recycle Bin so |
| | that it can no longer be restored. |
| Restore | Move the selected GPO from the Recycle Bin to |
| | Controlled. This does not restore the GPO to |
| | the production environment. |
| Miscellaneous | |
| Refresh | Update the display of Group Policy Management |
| | Console to incorporate any changes. Some |
| | changes are not visible until the screen is |
| | refreshed. |
| Help | Display context-sensitive help for GPOVault |

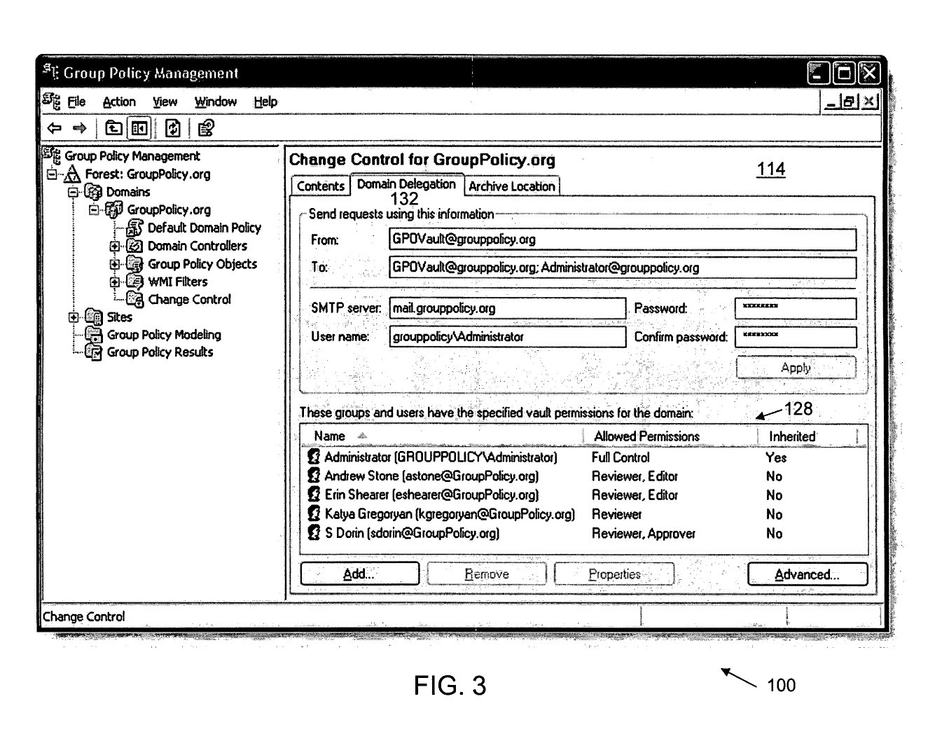

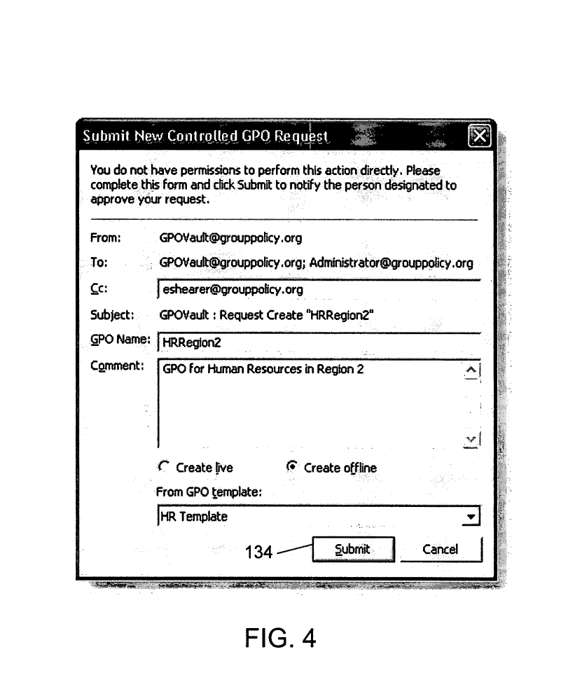

FIG. 3 illustrates the graphical user interface 100 in which “Domain Delegation” tab 132 is chosen. Lower pane 128 now displays a listing of groups and users that “have the specified vault permissions for the domain”. Right pane 114 now displays email address information for the subject domain via which the user may request permission to take a contemplated action when that permission has not been allowed for the user. If a user wishes to take an action for which the user does not have permission, e.g., by clicking on the “Add” icon, GPOVauIt™ provides a warning and prepares an email for forwarding, as illustrated in the exemplary warning of FIG. 4 for a user wishing to “Submit New Controlled GPO Request”. The user fills in the appropriate fields in FIG. 4, indicating the action being requested and clicks the “Submit” button 134 to send the email for processing.

The “Domain Delegation” tab 132 of FIG. 3 further enables a GPOVault™ Administrator to set permissions for Editors, Approvers and Reviewers. By default in GPOVault™, only Approvers may deploy GPOs to the production environment, Reviewers are able to view GPO settings in reports without being able to alter the GPO settings, and Editors may edit GPOs, but not deploy them. TABLE VI illustrates sample default permissions for various roles described herein. In addition, TABLES VII-VIII illustrate permissions that may be granted at the domain level and GPO level, respectively. In TABLES VI-VIII: x denotes that an individual having this role has the necessary permissions to perform the task; (x) denotes that the individual who creates or controls the GPO has full control, while others in the role do not; D denotes that delegating GPO-level permissions requires List Contents permission at the domain level; 1 denotes that the task requires at least one of the permissions; 1 denotes that the task requires at least one of the permissions and that an individual having only this permission must be the Editor who checked out the GPO; and * denotes that only the individual who checked out the GPO or the Administrator can perform this task. The permissions and roles in TABLES VI-VIII are provided for illustrative purposes and not for limitation. Other embodiments having fewer or more roles and varying permissions may be implemented.

TABLE VI

| | Default Permissions For Roles | | | | | | | | |
|---|---|---|---|---|---|---|---|---|---|
| | List | Read | Edit | Create | Deploy | Delete | Modify | Modify | Create |
| | Contents | Settings | Settings | GPO | GPO | GPO | Options | Security | Template |
| Reviewer | ✓ | ✓ | | | | | | | |
| Editor | ✓ | ✓ | ✓ | | | | | | ✓ |
| Approver | ✓ | ✓ | | ✓ | ✓ | ✓ | | | |
| GPOVault | ✓ | ✓ | ✓ | ✓ | ✓ | ✓ | ✓ | ✓ | ✓ |
| Administrator | | | | | | | | | |
| (Full Control) | | | | | | | | | |

TABLE VII

| | GPOVault Tasks, Permissions, and Roles | | | | | | | | |
|---|---|---|---|---|---|---|---|---|---|
| | Domain-Level Permission Actions and Tasks | | | | | | | | |
| | Permissions | | | | | | | | |
| | List | Read | Edit | Create | Deploy | Delete | Modify | Modify | Create |
| | Contents | Settings | Settings | GPO | GPO | GPO | Options | Security | Template |
| Delegate domain-level permissions | | | | | | | | ✓ | |
| Configure email notification | ✓ | | | | | | ✓ | | |
| View mail notification settings | ✓ | ✓ | | | | | | | |
| Create a GPO or approve creation | ✓ | | | ✓ | | | | | |
| Request creation of a GPO | ✓ | | | | | | | | |
| Control an uncontrolled GPO | ✓ | | | ✓ | | | | | |
| Request control of an uncontrolled GPO | ✓ | ✓ | | | | | | | |
| Create a template | ✓ | | | | | | | | ✓ |
| Set default template for | ✓ | | | | | | | | ✓ |
| creating new GPOs | | | | | | | | | |
| List GPOs | ✓ | | | | | | | | |

| | GPOVault Tasks, Permissions, and Roles | | | |
|---|---|---|---|---|
| | Domain-Level Permission Actions and Tasks | | | |
| | Roles | | | |
| | | | | GPOVault |
| | | | | Administrator |
| | Reviewer | Editor | Approver | (Full Control) |
| Delegate domain-level permissions | | | | X |
| Configure email notification | | | | X |
| View mail notification settings | X | X | X | X |
| Create a GPO or approve creation | | | X | X |
| Request creation of a GPO | X | X | | |
| Control an uncontrolled GPO | | | X | X |
| Request control of an uncontrolled GPO | X | X | | |
| Create a template | | X | | X |
| Set default template for | | X | | X |
| creating new GPOs | | | | |
| List GPOs | X | X | X | X |

TABLE VIII

| | GPOVault Tasks, Permissions, and Roles | | | | | | | | |
|---|---|---|---|---|---|---|---|---|---|
| | GPO-Level Permission Actions and Tasks | | | | | | | | |
| | Permissions | | | | | | | | |
| | List | Read | Edit | Create | Deploy | Delete | Modify | Modify | Create |
| | Contents | Settings | Settings | GPO | GPO | GPO | Options | Security | Template |
| Delegate GPO-level permissions | D | | | | | | | ✓ | |
| Deploy a GPO or approve deployment | ✓ | | | | ✓ | | | | |
| Change GPO links during deployment | ✓ | ✓ | | | ✓ | | | | |
| Request deployment of a GPO | ✓ | | ✓ | | | | | | |
| Delete a GPO archive (move to Recycle | ✓ | | 1 | | | 1 | | | |
| Bin/uncontrol) or approve deletion | | | | | | | | | |
| Delete a deployed GPO or approve deletion | ✓ | | | | | ✓ | | | |
| Request deletion of a deployed GPO | ✓ | | ✓ | | | | | | |
| Delete a template | ✓ | | | | | ✓ | | | |
| Destroy a GPO | ✓ | | | | | ✓ | | | |
| Restore a GPO | ✓ | | 1 | | 1 | 1 | | | |
| Archive a GPO | ✓ | | 1 | | 1 | 1 | | | |
| Check out a GPO | ✓ | | ✓ | | | | | | |
| Edit a GPO | ✓ | | * | | | | | | |
| Rename a GPO | ✓ | | ✓ | | | | | | |
| Label a GPO | ✓ | | 1 | | 1 | | | | |
| Check in a GPO/undo check out | ✓ | | 1 | | 1 | | | | |
| View GPO history | ✓ | | | | | | | | |
| View reports or GPO links | ✓ | ✓ | | | | | | | |

| | GPOVault Tasks, Permissions, and Roles | | | |
|---|---|---|---|---|
| | GPO-Level Permission Actions and Tasks | | | |
| | Roles | | | |
| | | | | GPOVault |
| | | | | Administrator |
| | Reviewer | Editor | Approver | (Full Control) |
| Delegate GPO-level permissions | | | (X) | X |
| Deploy a GPO or approve deployment | | | X | X |
| Change GPO links during deployment | | | X | X |
| Request deployment of a GPO | | X | | |
| Delete a GPO archive (move to Recycle | | X | X | X |
| Bin/uncontrol) or approve deletion | | | | |
| Delete a deployed GPO or approve deletion | | | X | X |
| Request deletion of a deployed GPO | | X | | |
| Delete a template | | | X | X |
| Destroy a GPO | | | X | X |
| Restore a GPO | | X | X | X |
| Archive a GPO | | X | X | X |
| Check out a GPO | | X | (X) | X |
| Edit a GPO | | X | (X) | X |
| Rename a GPO | | X | (X) | X |
| Label a GPO | | X | X | X |
| Check in a GPO/undo check out | | X | X | X |
| View GPO history | X | X | X | X |
| View reports or GPO links | X | X | X | X |

In any case, embodiments described herein may provide an administrator the flexibility to customize permissions to suit the needs of the network or organization. For example, using the “Add”, “Remove”, “Properties” and “Advanced” buttons shown in FIG. 3, an Administrator can configure domain-wide permissions. The “Add” and “Remove” buttons allow adding or removing a new entry to the security descriptor or the Access Control List for the selected GPO. The “Properties” button displays the properties for the selected GPO and the “Advanced” button opens the Access Control List Editor.

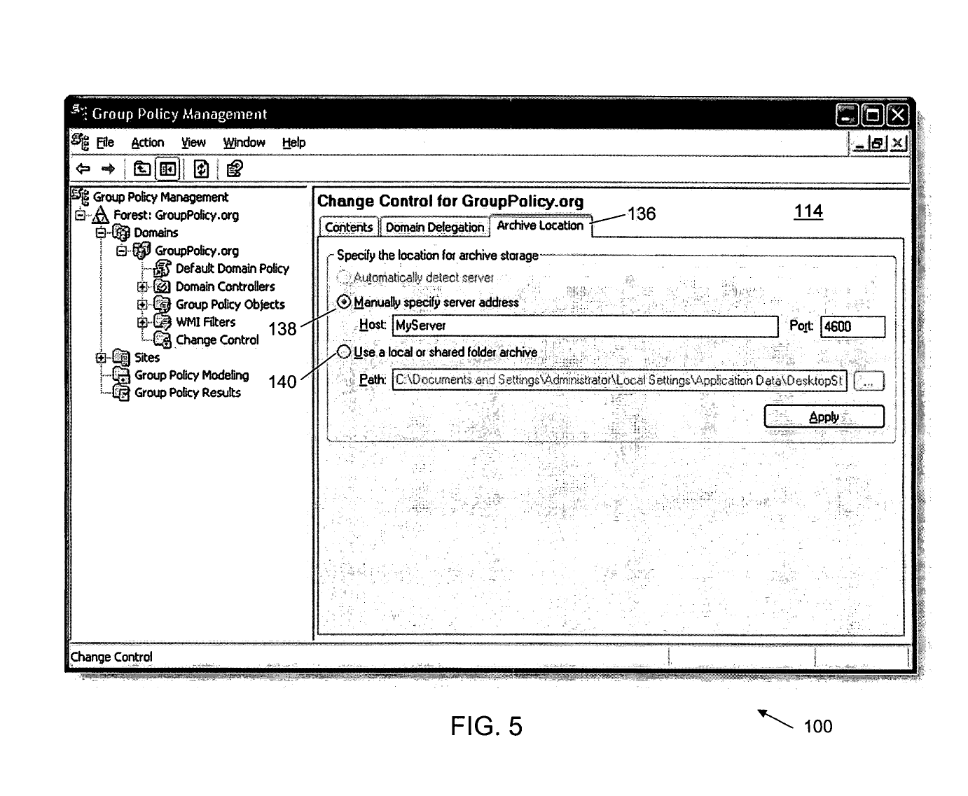

FIG. 5 illustrates the graphical user interface 100 in which “Archive Location” tab 136 is chosen. In right pane 114, the user is given a choice for the location of archive storage. Preferably, GPOVauIt™ is configured for operation in a client-server environment (button 138), with the archive stored on a server that provides the GPOVault™ service to the client such that the client merely requires the user interface. However, in some embodiments, GPOVault™ may operate in a stand-alone environment (button 140) with the archive stored in a local client or shared folder, and with the client having complete GPOVault™ functionality for archive creation, access, display, manipulation, etc. However, the stand-alone version does not provide the access security measures available with the client-server version.

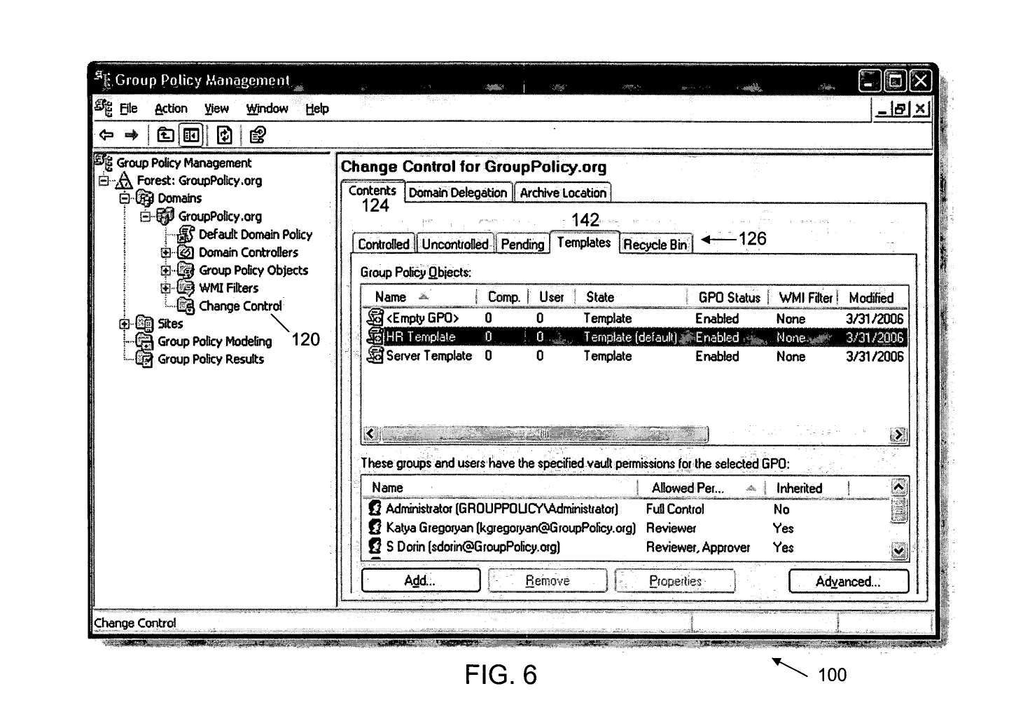

FIG. 6 illustrates the graphical user interface 100 in which “Contents” presentation tab 124 and “Templates” tab 142 of listing tabs 126 are chosen to display a listing of “Template” GPOs. A “Template” GPO may be used as a base GPO for creating new GPOs, in the manner known in the word processing art of using template documents or forms for creating new documents. When a “Template” GPO is created, it is stored in the archive and the AD in the manner to be described for other GPOs. However, the “Template” GPO settings are not applied on any client computers.

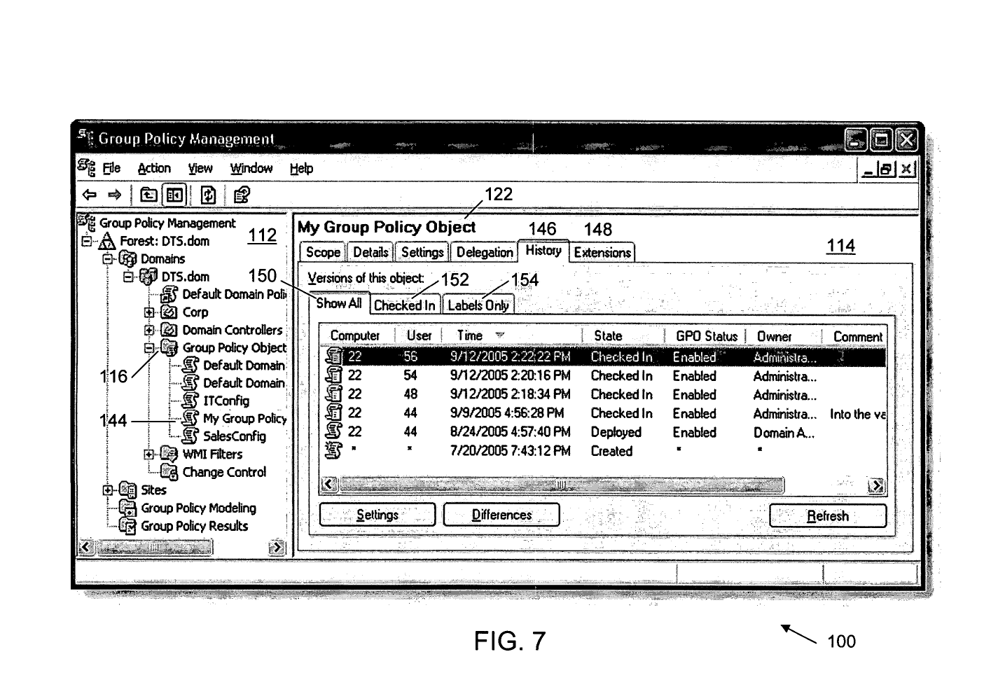

FIG. 7 illustrates the graphical user interface 100, wherein Group Policy Objects node 116 is expanded in left pane 112 to indicate the containers therein, including the standard WINDOWS® GPMC container. In FIG. 7, “My Group Policy Object” container 144 has been highlighted, as indicated by title 122 “My Group Policy Object” in right pane 114. In addition to the standard “Scope”, “Details”, Settings” and “Delegation” tabs provided by WINDOWS® GPMC in right pane 114, GPOVault™ extension provides new tabs, including “History” tab 146 and “Extension” tab 148. For graphical user interface 100 of FIG. 7, “History” tab 146 is chosen and right pane 114 shows a listing of versions of MyGPO. Without being limited thereto, tabs allow the listing to “Show All” (tab 150) versions, as in FIG. 7, show versions that are “Checked In” (tab 152) and show “Labels Only” (tab 154), i.e., versions that have labels associated with them.

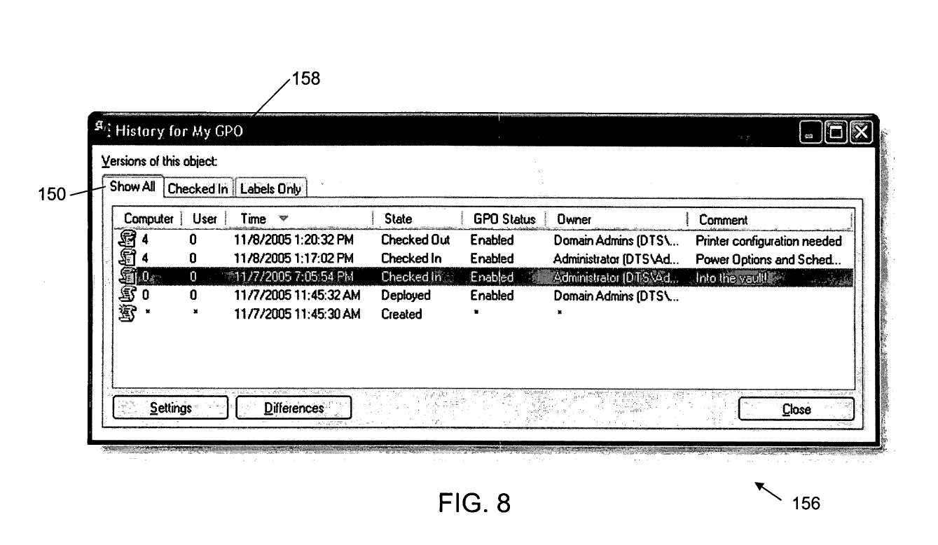

FIG. 8 illustrates a History Window 156 showing a “History for MyGPO” (title 158), using the “Show All” (tab 150), and generally corresponding to the listing in FIG. 7. In addition to “History” tab 146 illustrated in FIG. 7, a “History” of a GPO, as illustrated in FIG. 8, can be displayed by double-clicking a GPO or by right clicking on a GPO and clicking on “History”. For each version, listing 156 includes, without limitation, fields indicating the “Computer” and “User” that created the version, the “Time” the version was created, the current “State” of the version, the “GPO Status” of the version indicating whether the GPO is Enabled, the “Owner” of the version and a text field for a “Comment” regarding the version.

As is known, WINDOWS® GPMC does not maintain historical data with respect to edited GPOs, i.e., once an edited GPO is saved to the AD, no data regarding any previous version is available. In GPOVault™, a copy of each version of a GPO is maintained in the archive or vault, together with data regarding the version, including without limitation, the “Computer”, “User”, “Time”, “State”, “GPO Status”, “Owner” and “Comment” data described above. The “State” of the GPO can include without limitation, a “Deployed” state, indicating the version of the GPO is currently live on the network, a “Checked In” state, indicating the version is available for authorized users to check out for editing or for an Administrator to deploy, a “Checked Out” state, indicating the version is currently checked out and is not available for editing, a “Created” state, identifying the date and time of the initial creation of the GPO, and “Labeled”, identifying a labeled version of a GPO. In addition and referring to FIG. 2, the “Recycle Bin” tab 160 displays a list of GPOs that have been deleted from the archive, provides commands for restoring or destroying deleted GPOs and displays a list of the groups and users having permission to access each GPO.

WINDOWS® GPMC defines a backup format and includes Application Programming Interfaces (APIs) to manipulate and manage those single backup instances. GPOVault™ extends these instructions to build additional change management functionality. An XML file is used to define the archive, which is a collection of individual GPO backups, including all historical versions of the GPOs being managed. The XML file provides all necessary data required to manage the archive. The XML file is a hierarchical representation of the contents of the archive grouped by domain and then by GPO. The file structure is modeled after the hierarchy of the AD. The XML file is an index file that can be optimized for the needs of a change management process related to Group Policy management. Using standards based data formats, GPOVault™ provides an open mechanism to allow for future extensions or modifications. Choosing to use an open format for storage of meta-data describing contents of the archive, helps preclude issues surrounding closed or proprietary formats, including difficulty of support and intrusiveness.

This historical archive allows for a “roll back” of a live GPO to a chosen archived version. For example, a live GPO may be found to have an error therein. A user with the proper permission can replace the live GPO with a previous version of the GPO from the archive until the error can be corrected. While illustrated in FIGS. 7 and 8 for the My Group Policy Object container, GPOVault™ may add a “History” tab to all GPOs and Group Policy links displayed in WINDOWS® GPMC.

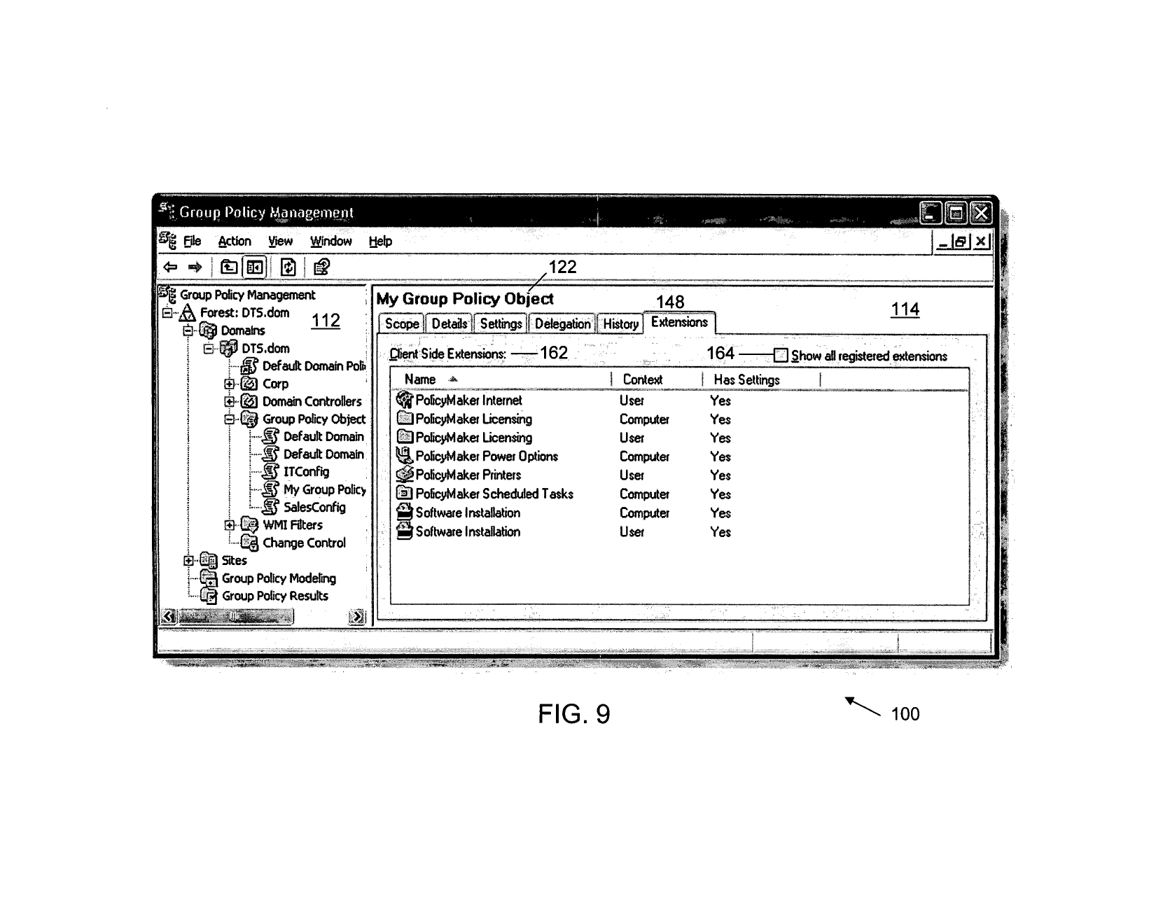

In addition to the “History” tab illustrated in FIGS. 7 and 8, GPOVault™ may add an “Extension” tab to all GPOs and Group Policy links displayed in WINDOWS® GPMC, as indicated in FIG. 9. Left pane 112 of graphical user interface 100, illustrated in FIG. 9 corresponds to that of FIG. 7. In right pane 114 of FIG. 9, “Extensions” tab 148 is chosen for “My Group Policy Object” (title 122) and a listing of corresponding “Client Side Extensions” (title 162) is provided, including without limitation, “Name” of the extension, the “Context” for the extension, i.e., whether the extension relates to the user or computer, and whether the extension “Has Settings”. The listing includes all extensions that have settings in the GPO. If the “Show all . . . ” box 164 is checked, the listing may show all registered extensions, including extensions not having settings in the selected GPO.

In addition to providing a listing of extensions and properties thereof, embodiments of change control management can include extension level delegation of permissions, i.e., permissions for “Editor”, “Reviewer”, “Administrator”, etc. can be set for individual extensions. By double-clicking on an extension, or right clicking on an extension and clicking on “Delegation”, a user having the appropriate permission can set permissions for the extension, in the manner described for setting permissions at the forest, domain and GPO levels, with respect to FIG. 3. The extension level delegation of permissions provides a method for applying the permissions to the settings owned by individual extensions within a GPO in that delegating or setting a permission for an extension results in the permission being set to grant or deny access to individual extensions. Thus, for example, a user that does not have “Editor” permission for a whole GPO, consisting of all extensions, may still have “Editor” permission for one or more extensions within the GPO. As another example, a user may have “Reviewer” permission for a GPO and have “Editor” permission for a particular extension that applies a particular class of settings within the GPO. In this case, the user can view all settings within the GPO but can edit and/or apply only those owned by the extension for which the user has “Editor” permissions. This capability allows organizations to delegate management task categories, such as security settings or software installation, in addition to management scope.

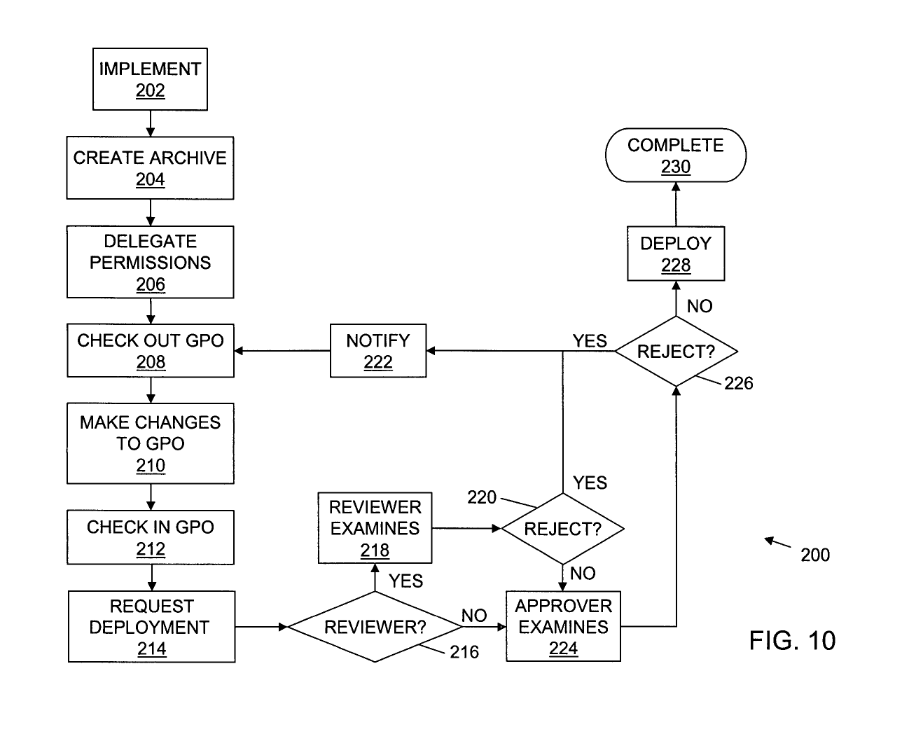

FIG. 10 illustrates a flow chart 200 for the operation of the described change control management methods and systems, wherein changes to a GPO are deployed. To provide the user interfaces and other functionalities described herein, an enhancement of the GPMC is implemented at 202. The archive is created (204) based on data from the AD and the Administrator may assign or delegate permissions (206) to users. For illustrative purposes and without limitation, creating the archive and delegating permissions are shown sequentially. However, it will be understood that these actions can be performed in any or no particular sequence. Further, the archive may be refreshed or updated at various times, including without limitation, periodic intervals, each time the “Change Control” node 120 is activated, when GPOs are checked in or out of the archive, when requested by a user and/or at other times as determined by an administrator. Further for illustrative purposes and without limitation, the blocks in flow chart 200 are described in relation to an Editor, Reviewer and Approver. However, the associated actions may be performed by any user having the appropriate permissions. For example and as shown in TABLE VIII, an Editor, Approver and/or an Administrator may edit a GPO.

As illustrated in the exemplary flow chart 200 for changing a GPO, an Editor checks out a copy of a GPO from the archive or vault (208). The Editor makes changes in the GPO (210) by opening the copy of the GPO in a GPO Editor and making the changes to the copy. The Editor then checks the updated GPO into the archive (212) and requests deployment of the GPO (214). As described herein, the request may be an email request to a Reviewer or Approver. If the request is to a Reviewer, as determined at (216), the Reviewer examines (218) the updated GPO. If errors or other considerations cause the Reviewer to reject the updated GPO, as determined at 220, the Editor is notified (222) so that he may check out the GPO for additional corrections or changes as required. Otherwise, the Reviewer forwards the GPO to an Approver. The Approver examines (224) the updated GPO. As in the case of the Reviewer, if the Approver rejects the updated GPO, as determined at 226, the Editor is notified (222) so that he may check out the GPO for additional corrections or changes as required. Otherwise, the Approver deploys (228) the updated version of the GPO to the production environment and the GPO update is complete (230).

The user interface and method embodiments described herein provide comprehensive change control and enhanced management for GPOs by adding change control, notification, approval, rollback, offline editing, and difference reporting directly into the WINDOWS® GPMC on AD networks and by providing a secure archive or vault for controlling changes to GPOs. To change a GPO, a user “checks out” the GPO from the vault. When changes are complete, the GPO is “checked in” to the vault. Differences between archived versions and/or live versions are reviewed using GPMC-style reports. When a GPO is ready for deployment, it can be transferred to the live environment. At any time, one or more live GPOs can be “rolled back” to an archived version.

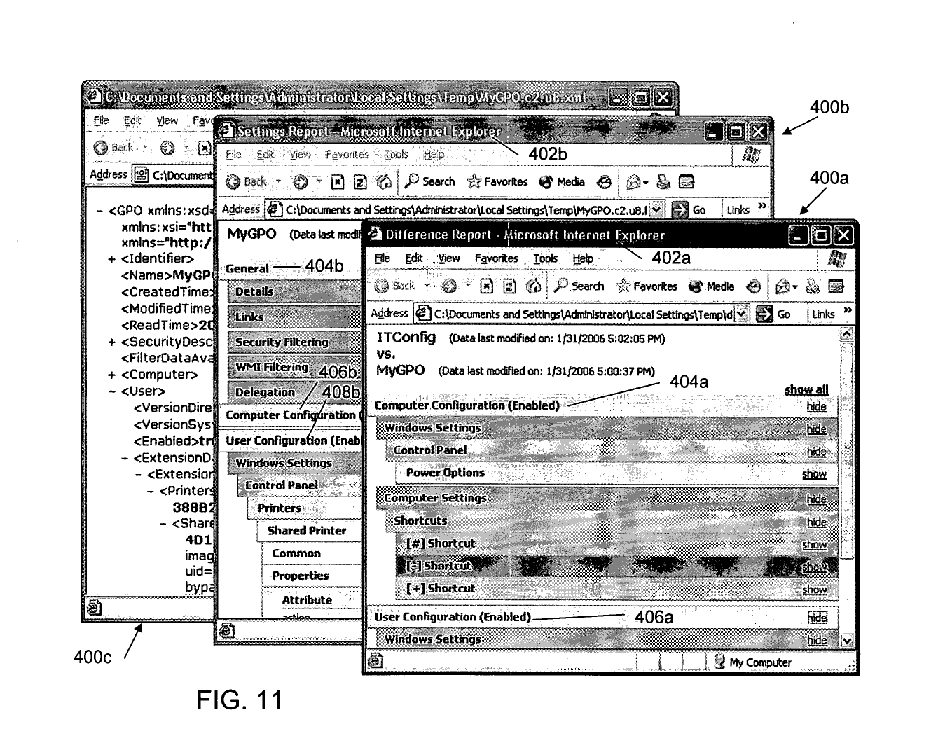

Referring to FIG. 11, there are illustrated cascaded user interfaces 400a, 400b and 400c displaying, respectively, a Difference Report (title 402a) for GPOs ITConfig and MyGPO, a Settings Report (title 402b) and a portion of the archive for a setting selected in the Difference or Settings Report. As described with relation to FIG. 2, “Reports” is one of the options provided when right clicking on a GPO. When two GPOs are highlighted and right clicked and the “Differences” option is chosen, GPOVault™ generates and displays Difference Report 402a, including without limitation Computer Configuration settings (title 404a) and User Configuration settings (title 406a). Under each heading (404a, 406a), a listing of settings is displayed, with indications for items that exists in both GPOs, but with changed settings [#], items that exist only in the first GPO [−] and items that exist only in the second GPO [+]. No indication is shown for items that exist with identical settings in both GPOs. Difference Reports may also be generated for comparing a GPO and a template GPO or for comparing two template GPOs.

When a single GPO is highlighted and right clicked and the “Settings” option is chosen, GPOVault™ generates and displays Settings Report 402b, including without limitation General GPO data (title 408b), Computer Configuration settings (title 404b) and User Configuration settings (title 406b). Under each heading (404b, 406b, 408b), a listing of data or settings is displayed. If a setting is selected from the Difference Report or from the Settings Report, GPOVault™ displays the archive beginning at the portion corresponding to the setting selected, as illustrated in user interface 400c.

As described herein, the embodiments provide opportunities to leverage investments in WINDOWS® Active Directory by using native tools and technologies to better manage standardization, security and compliance. The use of native tools provides further leverage in that there is no new console to learn. Also, the described embodiments utilize the native GPMC backup data format to preserve two-way portability of archived data.

The described embodiments may enhance lifecycle management of group policy by controlling, standardizing and auditing the creation, deployment and destruction of GPOs. Risks of widespread failures resulting from improperly planned or poorly understood application of potentially crippling policy settings may be reduced by providing offline editing, difference reporting and change control to stabilize the policy management process. The described embodiments preserve a robust delegation model by assigning control over individual GPOs to specific administrators, with or without giving them the power to modify other GPOs or deploy to the live environment. Role-based administration consistent with existing administrator roles may be implemented and common roles such as editor, reviewer and approver may be implemented at all levels, including extension level delegation for settings within a GPO.

By allowing administrators to subscribe to policy change email notifications and quickly approve change requests, the described embodiments provide for efficient policy work flow. The tracking of historical data and maintenance of all GPO versions in the archive allows users to know what has changed in their Group Policy environment, to recover deleted GPOs using an archived version and to quickly rollback deployed changes to a prior state, for individual or multiple GPOs. The described embodiments allow for the creation of a GPO template library so as to manage the creation of new GPOs for common scenarios and to configure local GPOs on remote computers. Extension level versioning provides for efficient GPO refreshes.

While certain embodiments have been described herein in relation to user interfaces for GPOVault™, such descriptions and figures are provided for illustrative purposes only. The disclosed methods and systems are not limited to such example embodiments, and may be understood to apply to other group and/or policy-based management systems, techniques and user interface configurations. For example, embodiments need not be fully integrated with WINDOWS® GPMC. While such embodiments may not provide the full advantages described above, advantages relating to the use of the archive and other features of the described embodiments may still be realized.

Thus, the methods and systems described herein are not limited to a particular hardware or software configuration, and may find applicability in many computing or processing environments. The methods and systems may be implemented in hardware or software, or a combination of hardware and software. The methods and systems may be implemented in one or more computer programs, where a computer program may be understood to include one or more processor executable instructions. The computer program(s) may execute on one or more programmable processors, and may be stored on one or more storage medium readable by the processor (including volatile and non-volatile memory and/or storage elements), one or more input devices, and/or one or more output devices. The processor thus may access one or more input devices to obtain input data, and may access one or more output devices to communicate output data. The input and/or output devices may include one or more of the following: Random Access Memory (RAM), Redundant Array of Independent Disks (RAID), floppy drive, CD, DVD, magnetic disk, internal hard drive, external hard drive, memory stick, or other storage device capable of being accessed by a processor as provided herein, where such aforementioned examples are not exhaustive, and are for illustration and not limitation.

The computer program(s) may be implemented using one or more high level procedural or object-oriented programming languages to communicate with a computer system; however, the program(s) may be implemented in assembly or machine language, if desired. The language may be compiled or interpreted.

As provided herein, the processor(s) may thus be embedded in one or more devices that may be operated independently or together in a networked environment, where the network may include, for example, a Local Area Network (LAN), wide area network (WAN), and/or may include an intranet and/or the internet and/or another network. The network(s) may be wired or wireless or a combination thereof and may use one or more communications protocols to facilitate communications between the different processors. The processors may be configured for distributed processing and may utilize, in some embodiments, a client-server model as needed. Accordingly, the methods and systems may utilize multiple processors and/or processor devices, and the processor instructions may be divided amongst such single or multiple processor/devices.

The device(s) or computer systems that integrate with the processor(s) may include, for example, a personal computer(s), workstation (e.g., Sun, HP), personal digital assistant (PDA), handheld device such as cellular telephone, laptop, handheld, or another device capable of being integrated with a processor(s) that may operate as provided herein. Accordingly, the devices provided herein are not exhaustive and are provided for illustration and not limitation.

References to “a microprocessor” and “a processor”, or “the microprocessor” and “the processor,” may be understood to include one or more microprocessors that may communicate in a stand-alone and/or a distributed environment(s), and may thus may be configured to communicate via wired or wireless communications with other processors, where such one or more processor may be configured to operate on one or more processor-controlled devices that may be similar or different devices. Use of such “microprocessor” or “processor” terminology may thus also be understood to include a central processing unit, an arithmetic logic unit, an application-specific integrated circuit (IC), and/or a task engine, with such examples provided for illustration and not limitation.

Furthermore, references to memory, unless otherwise specified, may include one or more processor-readable and accessible memory elements and/or components that may be internal to the processor-controlled device, external to the processor-controlled device, and/or may be accessed via a wired or wireless network using a variety of communications protocols, and unless otherwise specified, may be arranged to include a combination of external and internal memory devices, where such memory may be contiguous and/or partitioned based on the application. Accordingly, references to a database may be understood to include one or more memory associations, where such references may include commercially available database products (e.g., SQL, Informix, Oracle) and also proprietary databases, and may also include other structures for associating memory such as links, queues, graphs, trees, with such structures provided for illustration and not limitation.

References to a network, unless provided otherwise, may include one or more intranets and/or the internet. References herein to microprocessor instructions or microprocessor-executable instructions, in accordance with the above, may be understood to include programmable hardware.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” or “an” to modify a noun may be understood to be used for convenience and to include one, or more than one of the modified noun, unless otherwise specifically stated.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art. Accordingly, it will be understood that the disclosed methods and systems are not to be limited to the embodiments disclosed herein, may include practices otherwise than specifically described, and are to be interpreted as broadly as allowed under the law.

What is claimed is:

1. A method for change control management of group policy objects for a network, the method comprising:
creating an archive of group policy objects on a server,
assigning permissions to users for performing at least one operation of editing, reviewing and approving of changes to the group policy objects in the archive,
implementing an enhancement of a group policy management control user interface on a client to provide a node in the user interface, whereby a user can access change control management tools for performing the at least one operation of editing, reviewing and approving of changes to group policy objects in the archive consistent with the permissions assigned to the user, and
deploying only approved changes from the archive to an active directory for the network.

2. A method of claim 1, wherein creating an archive comprises maintaining copies of previous and current versions of the group policy objects.

3. A method of claim 2, wherein creating an archive comprises creating an XML file including, for each group policy object version, a group unique identifier and version data, the user interface accessing the XML file for displaying the version data to the user.

4. A method of claim 3, wherein the version data comprises client meta-data, including at least one of user data, time data, state data, status data, owner data and text data for identifying at least one of a creation of a version, a current state of a version, an enabled status of a version and comments regarding the version.

5. A method of claim 4, wherein the state data of a version identifies at least one of a deployed state when the version is currently live on the network, a checked in state, indicating the version is available for at least one of editing and deployment to the active directory, and a checked out state, indicating the version is currently checked out and is not available for editing.

6. A method of claim 1, wherein assigning permissions comprises assigning at least one permission to at least one setting within a group policy object without assigning the at least one permission to other settings within the group policy object.

7. A method of claim 1, wherein deploying comprises:
reviewing changes made to the at least one of the group policy objects, and
approving the changes made to the at least one of the group policy objects.

8. A data structure for change control management of group policy objects for a network, the data structure residing on a server and comprising:
an archive of previous and current versions of the group policy objects, and
an XML file including, for each group policy object version, a group unique identifier and version data, wherein a change control management user interface accesses the XML file to display the version data to a user on a client.

9. A data structure of claim 8, wherein the version data comprises client meta-data, including at least one of user data, time data, state data, status data, owner data and text data for identifying at least one of a creation of a version, a current state of a version, an enabled status of a version and comments regarding the version.

10. A data structure of claim 9, wherein the state data of a version identifies at least one of a deployed state when the version is currently live on the network, a checked in state, indicating the version is available for at least one of editing and deployment to the active directory, and a checked out state, indicating the version is currently checked out and is not available for editing.

11. A method for change control management of group policy objects for a network, the method comprising:
creating an archive of group policy objects on a server,
allowing an administrator of the method to assign a permission to a user for at least one of editing, reviewing and approving changes to a setting within a group policy object in the archive without assigning the user a permission regarding other settings within the group policy object,
allowing a user to perform at least one of editing, reviewing and approving a change to at least one setting within a group policy object based on the permissions assigned to the user, and
deploying an approved change from the archive to an active directory for the network.

12. A method of claim 11, further comprising implementing an enhancement of a group policy management control user interface to provide a node in the user interface, whereby the user can access change control management tools for performing the at least one of editing, reviewing and approving consistent with the permissions assigned to the user.

13. A method of claim 11, wherein creating an archive comprises maintaining copies of previous and current versions of the group policy objects.

14. A method of claim 13, wherein creating an archive comprises creating an XML file including, for each group policy object version, a group unique identifier and version data, the user interface accessing the XML file for displaying the version data to the user.

15. A method of claim 14, wherein the version data comprises client meta-data, including at least one of user data, time data, state data, status data, owner data and text data for identifying at least one of a creation of a version, a current state of a version, an enabled status of a version and comments regarding the version.

16. A method of claim 15, wherein the state data of a version identifies at least one of a deployed state when the version is currently live on the network, a checked in state, indicating the version is available for at least one of editing and deployment to the active directory, and a checked out state, indicating the version is currently checked out and is not available for editing.

17. A method for change control management of group policy objects for a network, the method comprising:
creating an archive of group policy objects on a server,
assigning permissions to users for performing at least one operation of editing, reviewing and approving of changes to the group policy objects in the archive,
implementing an enhancement of a group policy management control in a client-server environment, whereby a user on a client can access change control management tools for performing the at least one operation of editing, reviewing and approving of changes to group policy objects in the archive consistent with the permissions assigned to the user, and
deploying only approved changes from the archive to an active directory for the network.

18. A method of claim 17, wherein implementing comprises implementing an enhancement of a group policy management control user interface to provide a node in the user interface for accessing the access change control management tools.

19. A method of claim 17, wherein creating an archive comprises maintaining copies of previous and current versions of the group policy objects.

20. A method of claim 19, wherein creating an archive comprises creating an XML file including, for each group policy object version, a group unique identifier and version data, the user interface accessing the XML file for displaying the version data to the user.

21. A method of claim 20, wherein the version data comprises client meta-data, including at least one of user data, time data, state data, status data, owner data and text data for identifying at least one of a creation of a version, a current state of a version, an enabled status of a version and comments regarding the version.

22. A method of claim 21, wherein the state data of a version identifies at least one of a deployed state when the version is currently live on the network, a checked in state, indicating the version is available for at least one of editing and deployment to the active directory, and a checked out state, indicating the version is currently checked out and is not available for editing.

23. A method of claim 17, wherein assigning permissions comprises assigning at least one permission to at least one setting within a group policy object without assigning the at least one permission to other settings within the group policy object.

24. A method of claim 17, wherein deploying comprises:
reviewing changes made to the at least one of the group policy objects, and
approving the changes made to the at least one of the group policy objects.
